(19) United States
(12) Patent Application Publication
(10) Pub. No.: US 2011/0025828 A1
(43) Pub. Date: Feb. 3, 2011

(54) IMAGING APPARATUS AND METHOD FOR CONTROLLING THE SAME

(76) Inventor: Eiji Ishiyama, Miyagi (JP)

Correspondence Address: BIRCH STEWART KOLASCH & BIRCH, PO BOX 747, FALLS CHURCH, VA, 22040-0747, US

(21) Appl. No.: 12/846,283

(22) Filed: Jul. 29, 2010

(30) Foreign Application Priority Data
Jul. 30, 2009 (JP) 2009-177536

(51) Int. Cl. H04N 13/02

(52) U.S. Cl. 348/47; 348/E13.074

(57) ABSTRACT

Multiple marks are attached to a subject. A camera shift direction is set to the right direction. Before capturing Nth (N is a natural number equal to or larger than 2) L and R images, (N−1)th L and R images are read from a memory card, and feature points common to the (N−1)th L and R images are extracted. At least three feature points located in a right edge portion of each of the (N−1)th L and R images are selected as guide points. The right edge portion containing all three guide points is cut out from each of the (N−1)th L and R images to generate L and R guide images which guide a next camera position. The L and R guide images are combined into the left edge portions of the L and R images (through images), respectively. The combined images are displayed on an LCD.

### FIELD OF THE INVENTION

The present invention relates to an imaging apparatus used for creating a 3D model of a subject, and a method for controlling this imaging apparatus.

### BACKGROUND OF THE INVENTION

Recently, with the wide spread use of the Internet and improvements in image processing efficiency, 3D (3 dimensional) models are used in product presentations and the like. A 3D model, also referred to as stereo model, shows a 3D shape of a product. Using this 3D model in a product presentation, a customer can see the product from any desirable angle and orientation on a screen of a personal computer or the like.

To create a 3D model of a product, first, using a multi-eye camera or digital camera having plural imaging units, multiple images of the product are captured from different camera positions shifted around the product to cover the entire outer surface of the product. Thereby, a pair of captured images (right image and left image) is obtained for each imaging field. Then, using a personal computer or the like, the right image and the left image are combined into a 3D image (also referred to as a partial 3D model, a distance image, or 3D shape data) showing a partial 3D shape of the product in each imaging field. Thereafter, the 3D images are overlapped and synthesized to create a 3D model of the entire product.

To synthesize the 3D images to create a 3D model, edge portions of the adjacent 3D images need to be overlapped. When the entire outer surface of the product is captured in multiple image captures from different camera positions shifted around the subject, the camera position needs to be shifted so as to capture an image with its edge portions overlapped with the adjacent imaging fields (images).

Japanese Patent Laid-Open Publications No. 2000-299804 and No. 2004-312549 describe a panorama camera which displays a guide image over a through image to guide a camera position so as to overlap edge portions or boundaries of adjacent imaging fields with each other. The camera of Japanese Patent Laid-Open Publication No. 2000-299804 cuts out a right edge portion of the last captured image with a predetermined width to form a guide image when the camera position is shifted to the right for the next image capture, for example. The guide image is displayed being overlapped on a left edge portion of the through image. The camera of Japanese Patent Laid-Open Publication No. 2004-312549 displays two frames of images, the last captured image and the through image, partly overlapped with each other.

The multi-eye camera captures two images, a right image and a left image, of a product (subject) from two different viewpoints, a right viewpoint and a left viewpoint. A 3D image is obtained from image information of an overlapping portion or common portion between imaging fields of the right image and the left image. Generally, therefore, an imaging field of the obtained 3D image is smaller than those of the right image and left image. In other words, even if images are captured using the multi-eye camera with shifted camera positions, and right and left images are captured with their imaging fields partly overlapped with those of the last captured right and left images, respectively, the created 3D images may not necessarily be overlapped with each other. In this case, information for the synthesis of the 3D images cannot be obtained. As a result, the synthesis of the 3D images is failed to degrade image quality of the 3D model.

The cameras disclosed in Japanese Patent Laid-Open Publications No. 2000-299804 and No. 2004-312549 do not touch upon overlapping and synthesizing the 3D images. Accordingly, camera positions cannot be properly determined such that the 3D images partly overlap with each other, resulting in failure in synthesizing 3D images.

To precisely overlap and synthesize 3D images of adjacent imaging fields, it is necessary to change an overlap width of the adjacent imaging fields (3D images) depending on a shape of the subject. An imaging field of the 3D image varies depending on a distance between the camera and the subject. For example, when the camera is close to the subject, an overlap width of the adjacent 3D images needs to be increased. As the overlap width decreases available imaging fields for obtaining a 3D image decrease. Since the cameras disclosed in Japanese Patent Laid-Open Publications No. 2000-299804 and No. 2004-312549 have fixed overlap widths, the synthesis of 3D images may fail.

### SUMMARY OF THE INVENTION

An object of the present invention is to provide an imaging apparatus which enables a user to set the camera position properly when an entire subject is captured in multiple image captures and a method for controlling this imaging apparatus.

In order to achieve the above and other objects, the imaging apparatus of the present invention includes at least a first imaging unit and a second imaging unit with a space therebetween, a display section, a storage, a direction designation section, a feature point extractor, a guide point selector, a guide image generating section, and an image compositor. The display section displays a captured image captured with at least the first imaging unit as a through image during image capture of the through image. The storage stores two images captured with the first and second imaging units when the image capture is instructed. The imaging apparatus captures images of a subject from different camera positions shifted around the subject. The direction designation section designates a shift direction of a camera position. The feature point extractor reads two last stored images from storage, and extracts characteristic points common to the two last stored images as feature points. The guide point selector selects the feature points located at an edge portion of each of the two last stored images in the designated shift direction as guide points. The guide image generating section cuts out the edge portion containing the guide points from the last stored image obtained with at least the first imaging unit, and generates a guide image from the cut out edge portion to indicate an overlapping area of the last stored image and a next image to be stored. The guide image serves as a guide to determine a next camera position. The image compositor combines the guide image with the through image being displayed. The guide image is disposed at an edge portion of the through image opposite to the shift direction.

It is preferable that the guide point selector selects at least three of the feature points as the guide points in each of the two last stored images at the edge portion in the shift direction.

It is preferable that the guide point selector selects the guide points such that an area of a region defined by the guide points is equal to or larger than a predetermined value.

It is preferable that the imaging apparatus further includes a first display converter for changing a display condition of the guide points contained in the guide image to be relatively prominent on a screen of the display section.

It is preferable that the image compositor makes the guide image translucent and combines the translucent guide image with the through image.

It is preferable that the imaging apparatus further includes a storage controller for storing, in the storage, position information indicating the positions of the guide points in each of the two last stored images. The storage controller stores the position information in association with the corresponding last stored image.

It is preferable that the imaging apparatus further includes a second feature point extractor and a matching point extractor. The second feature point extractor extracts second feature points. The second feature points are characteristic points common to the two captured images to be stored in the storage when the image capture is instructed. The matching point extractor extracts from the second feature points in each of the two images a matching point corresponding to the guide point. It is preferable that based on an extraction result of the matching point extractor, the storage controller stores in the storage the position information indicating a position of the matching point in each of the two images in association with the corresponding captured image.

It is preferable that the storage controller stores, in the storage, correspondence information indicating correspondence between the guide points and the matching points.

It is preferable that the display section displays the two captured images as through images, and each of the captured images contains the second feature points and the matching points. It is preferable that the imaging apparatus further includes a second display converter for changing a display condition of the matching points in each of the through images to be relatively prominent on a screen of the display section.

A method for controlling an imaging apparatus includes a direction designating step, a feature point extracting step, a guide point selecting step, a guide image generating step, and a combining step. In the direction designating step, a shift direction of a camera position is designated. In the feature point extracting step, two last stored images are read from the storage, and from each of the two last stored images, characteristic points common to the two last stored images are extracted as feature points. In the guide point selecting step, the feature points located at an edge portion of each of the two last stored images in the designated shift direction are selected as guide points. In the guide image generating step, the edge portion containing the guide points is cut out from the last stored image obtained with at least the first imaging unit, and a guide image is generated from the cut out edge portion to indicate an overlapping area of the last stored image and a next image to be stored. The guide image serves as a guide to determine a next camera position. In the combining step, the guide image is combined with the through image being captured, and a combined image is displayed on the display section. The guide image is disposed at an edge of the through image in the opposite direction to the shift direction.

For the imaging apparatus and the method for controlling the imaging apparatus of the present invention, when images of a subject is captured from different camera positions, a guide image which serves as a guide to determine the next camera position is generated from the last stored image. The generated guide image is combined with a through image being captured. Accordingly, a camera position for the next image capture is determined properly and easily. Thus, 3D images of adjacent imaging fields are captured in a state that they are overlapped with each other. This prevents failure in synthesizing the 3D images to create a 3D model.

At least 3 guide points located at an edge portion in the camera shift direction are selected from among feature points contained in each of the last captured images to generate a guide image containing the selected guide points. Thereby, an image is captured such that 3 or more guide points are contained in each overlapping area of adjacent imaging fields. Based on the guide points, the adjacent 3D images are aligned for synthesis. The size of the guide image (overlapping area) enabling the alignment or image registration is properly determined.

The guide points are selected such that an area of a region defined by the guide points is equal to or larger than a predetermined value. Accordingly, the guide points are prevented from being aligned on a substantially straight line.

As a result, errors in positioning or aligning the 3D images are reduced (see FIGS. 15 and 16).

Changing the display condition of the guide points contained in the guide image to be relatively prominent on the screen facilitates to determine a camera position. In addition, changing the display condition of the matching points contained in the through image to be relatively prominent enhances the ease of determining a camera position.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a front perspective view of a multi-eye camera of an embodiment of the present invention;

FIG. 2 is a back perspective view of the multi-eye camera;

FIG. 3 is an explanatory view of a 3D model capture mode;

FIG. 4 is a perspective view of a subject to be captured in the 3D model capture mode;

FIG. 5 is a block diagram showing an electrical configuration of the multi-eye camera;

FIG. 6 is a block diagram of a guide image combining circuit shown in FIG. 5;

FIG. 7 is an explanatory view of an example of a folder structure of a memory card;

FIG. 8 is an explanatory view of information stored in POSITION.TXT;

FIG. 9 is a flowchart showing process steps in 3D model capture mode;

FIG. 10 is a flowchart showing steps in guide image combining process;

FIG. 11 is an explanatory view showing a mark extraction process performed by a mark extractor;

FIG. 12 is an explanatory view showing a mark extraction process performed by a feature point extractor;

FIG. 13 is an explanatory view showing a guide point selection process performed by a guide point selector when an area of a region S is smaller than a threshold value;

FIG. 14 an explanatory view showing the guide point selection process performed by a guide point selector when an area of a region S is equal to or larger than a threshold value;

FIG. 15 an explanatory view showing the region S with an area smaller than a threshold value;

FIG. 16 is an explanatory view showing the region S with an area equal to or larger than a threshold value;

FIG. 17 is an explanatory view showing a cut out process performed by a guide image cut out section;

FIG. 18 is an explanatory view showing L and R images used for through images before combining L and R guide images;

FIG. 19 is an explanatory view showing image combining process of the L and R images performed by an image compositor;

FIGS. 20A and 20B are explanatory views showing a display on an LCD during a camera position adjustment;

FIG. 21 is a block diagram of a guide image combining circuit of a second embodiment;

FIG. 22 is an explanatory view of L and R composite images combined by the guide image combining circuit of the second embodiment; and

FIG. 23 is an explanatory view of a configuration of an image file of another embodiment.

### DESCRIPTION OF THE PREFERRED EMBODIMENTS

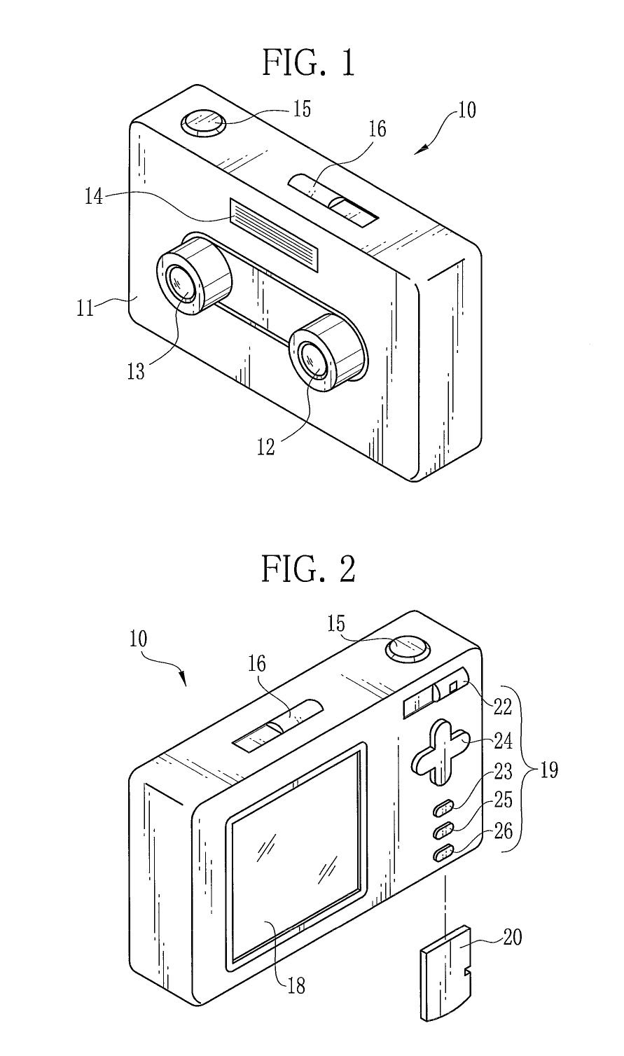

As shown in FIG. 1, an imaging apparatus, for example, a multi-eye camera 10 has a camera body 11. On a front face of the camera body 11, a pair of first and second imaging units 12 and 13, a flash emitter 14, and the like are provided. The first and second imaging units 12 and 13 have a space therebetween and are disposed with their optical axes being substantially parallel or becoming closer to each other toward the front like an inverted letter V. A release button 15 and a power switch 16 are provided on a top face of the camera body 11.

As shown in FIG. 2, a liquid crystal display (hereinafter abbreviated as LCD) 18 and an operating section 19 are provided on the back face of the camera body 11. A card slot (not shown) through which a memory card 20 is removably inserted and a lid for opening and closing the card slot are provided on a bottom face of the camera body 11.

The LCD 18 functions as an electronic viewfinder during framing, and displays a through image or live view image. The through image is a moving image or movie captured with the first and second imaging units 12 and 13 at a predetermined frame rate. The through images are not stored in the memory card 20. On the LCD 18, the image is reproduced and displayed based on still image data or moving image data stored in the memory card 20.

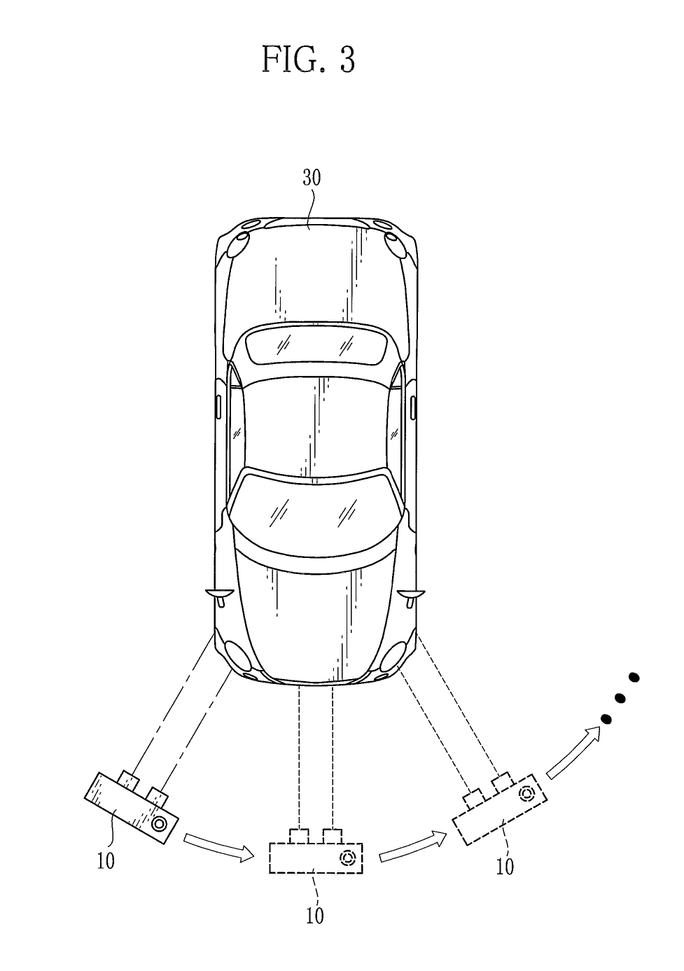

The operating section 19 is composed of a mode selection switch 22, a menu button 23, a cross key 24, an enter key 25, a direction designation switch 26, and the like. The mode selection switch 22 is operated to select one of operation modes of the multi-eye camera 10. The operation modes include a still image mode for taking a still image, a movie mode for taking a moving image, a panorama mode for generating a wide-angle panoramic image, a 3D model capture mode for generating a 3D model of a main subject 30 (see FIG. 3), a normal reproduction mode for reproducing and displaying a captured image on the LCD 18, a 3D model display mode for displaying a 3D model, and the like.

As shown in FIG. 3, in the 3D model capture mode, the multi-eye camera 10 divides an imaging field of the main subject 30 into plural portions and captures a stereo image for each portion from a camera position shifted around the main subject 30. Thus, multiple images (left image and right image) are obtained. The imaging field of each image partly overlaps with those of the adjacent images. In the 3D model display mode, the LCD 18 displays a 3D model generated based on the 3D images obtained in the 3D model capture mode.

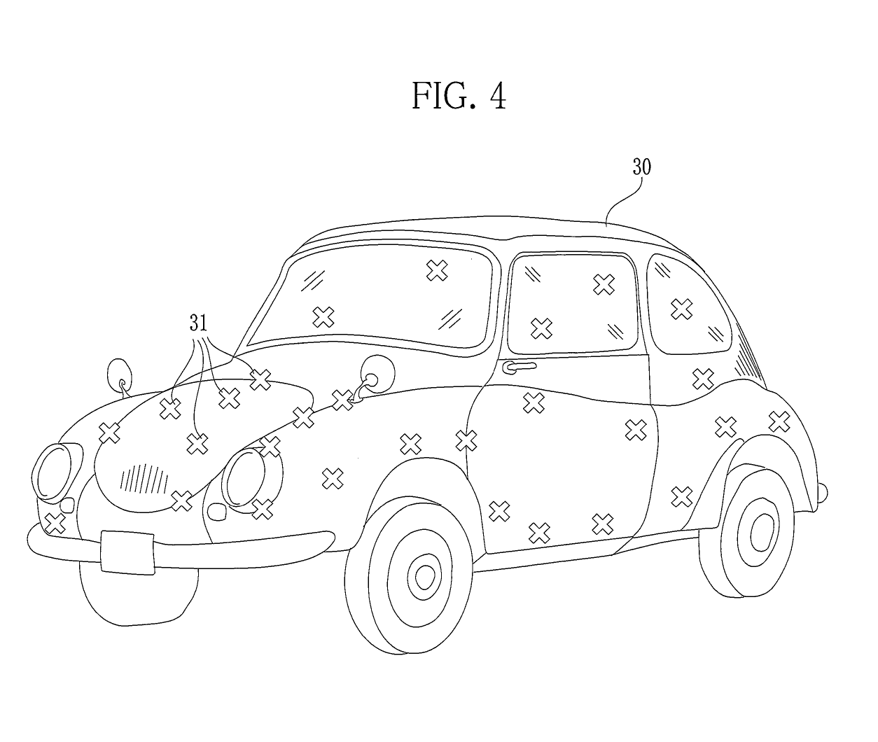

As shown in FIG. 4, multiple marks 31 or marking materials are previously attached to the main subject 30 to be captured in the 3D model capture mode. Accordingly, all images of the main subject 30 captured in the 3D model capture mode contain images of the marks 31. Based on the positions of the images of the marks 31, a position and orientation of the main subject 30 are calculated. The shape, the size, the number, and an arrangement of the marks 31 are selected as necessary.

In FIG. 2, the menu button 23 is operated when a menu screen or a setting screen is displayed on the LCD 18. Operating the cross key 24 moves a cursor displayed on the menu screen and the setting screen. The enter key 25 is operated to confirm the entry.

In the 3D model capture mode, operating the direction designation switch 26 designates a direction (hereinafter referred to as camera shift direction) to which a camera position of the multi-eye camera 10 is to be shifted. For example, as shown in FIG. 3, in the case where images are to be captured from the camera positions shifted to the right, the camera shift direction is designated as “right”. The camera shift direction can be designated in any direction as necessary. The camera shift direction may be designated through the setting screen.

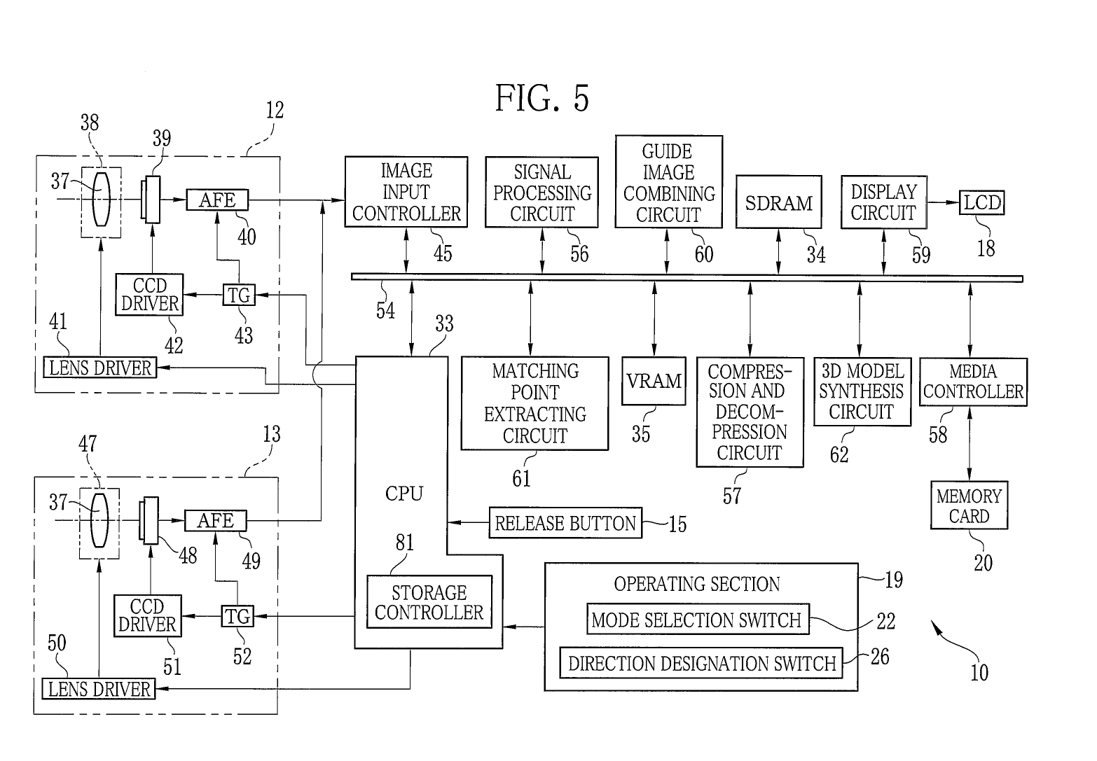

As shown in FIG. 5, a CPU 33 sequentially executes various programs and the like read from a ROM (not shown) based on input signals from the release button 15 and the operating section 19. Thus, the CPU 33 controls overall operations of the multi-eye camera 10.

An SDRAM 34 functions as a working memory for the CPU 33 to execute processes. A VRAM 35 has a memory area for storing two successive field images to temporarily store image data for displaying a through image.

The first imaging unit 12 is composed of a lens device 38 incorporating a lens system 37, a CCD image sensor (hereinafter referred to as CCD) 39, an AFE (analog front end) 40, and the like. Instead of the CCD 39, a MOS type image sensor may be used.

The lens device 38 incorporates a zoom mechanism, a focus mechanism, and an aperture drive mechanism. The zoom mechanism moves the lens system 37 to perform zooming. The focus mechanism moves the focus lens incorporated in the lens system 37 to adjust the focus. The aperture drive mechanism adjusts the aperture stop to adjust the intensity of subject light incident on the CCD 39. The CPU 33 controls the operations of the zoom mechanism, the focus mechanism, and the aperture drive mechanism through a lens driver 41.

Behind the lens system 37, the CCD 39 having a plurality of photodiodes arranged on its light receiving surface is disposed. The CCD 39 converts the subject light from the lens system 37 into electric image signals and outputs them. A CCD driver 42, controlled by the CPU 33, is connected to the CCD 39. The CCD driver 42 is driven by synchronization pulses from a TG (timing generator) 43, and controls a charge accumulation time, a charge readout, and a transfer timing of the CCD 39.

The image signals output from the CCD 39 are input to the AFE 40. The AFE 40 is composed of a CDS (correlated double sampling) circuit, an AGC (automatic gain amplifier), and an A/D converter (all not shown). Upon input of the synchronization pulses from the TG 43, the AFE 40 actuates in synchronization with charge readout and transfer operations of the CCD 39. The CDS circuit performs correlated double sampling to remove noise from the image signals. The AGC circuit amplifies the image signals with a gain based on ISO sensitivity set by the CPU 33. The A/D converter converts an analog image signal from the AGC circuit into a digital image signal or left image signal (hereinafter abbreviated as L image signal), and sends the L image signal to an image input controller 45.

The second imaging unit 13 has the same configuration as the first imaging unit 12, and is composed of a lens device 47, a CCD 48, an AFE 49, a lens driver 50, a CCD driver 51, and a TG 52. The second imaging unit 13 sends a right image signal (hereinafter abbreviated as R image signal) to the image input controller 45.

To the CPU 33, the SDRAM 34, the VRAM 35, the image input controller 45, a signal processing circuit 56, a compression and decompression processing circuit 57, a media controller 58, a display circuit 59, a guide image combining circuit 60, a matching point extracting circuit 61, a 3D model synthesis circuit 62, and the like are connected through a bus 54.

The image input controller 45 has a buffer with a predetermined capacity, and accumulates the L image signal from the first imaging unit 12 and the R image signal from the second imaging unit 13 in the buffer. When L image signals of one frame and R image signals of one frame are accumulated in the buffer, the accumulated L image signals of one frame and the accumulated R image signals of one frame are sent to the signal processing circuit 56.

The signal processing circuit 56 performs various processes such as tone conversion, white balance correction, gamma correction, and YC conversion to each of the L image signal and the R image signal, and generates one frame of the L image data and one frame of the R image data, and stores the generated L image data and R image data in the VRAM 35.

When the release button 15 is pressed, the compression and decompression processing circuit 57 compresses the uncompressed L image data and R image data stored in the VRAM 35, and generates compressed L image data and R image data in a predetermined file format. To reproduce the stored image, the compression and decompression processing circuit 57 decompresses the compressed L image data and R image data stored in the memory card 20 to generate the uncompressed L image data and R image data. The media controller 58 reads and stores the image data in the memory card 20.

The display circuit 59 performs predetermined signal processes to the L and R image data read from the VRAM 35, or the L and R image data decompressed in the compression and decompression processing circuit 57 to generate signals for the image display. The generated signals are output to the LCD 18 at a constant time interval. In each image capture mode, the left through image (hereinafter abbreviated as L through image) and the right through image (hereinafter abbreviated as R through image) are displayed side by side on the LCD 18. In the normal reproduction mode, the image data read from the memory card 20 is displayed on the LCD 18. In the 3D model display mode, the display circuit 59 displays a 3D model on the LCD 18 based on the 3D model data read from the memory card 20.

The guide image combining circuit 60 actuates in the 3D model capture mode. During the standby for the image capture of Nth (N is a natural number equal to or larger than 2) L image and R image, the guide image combining circuit 60 generates guide image data (L guide image data and R guide image data) for guiding the camera position. The guide image combining circuit 60 combines the generated L and R guide image data with the L and R image data of the through image, respectively.

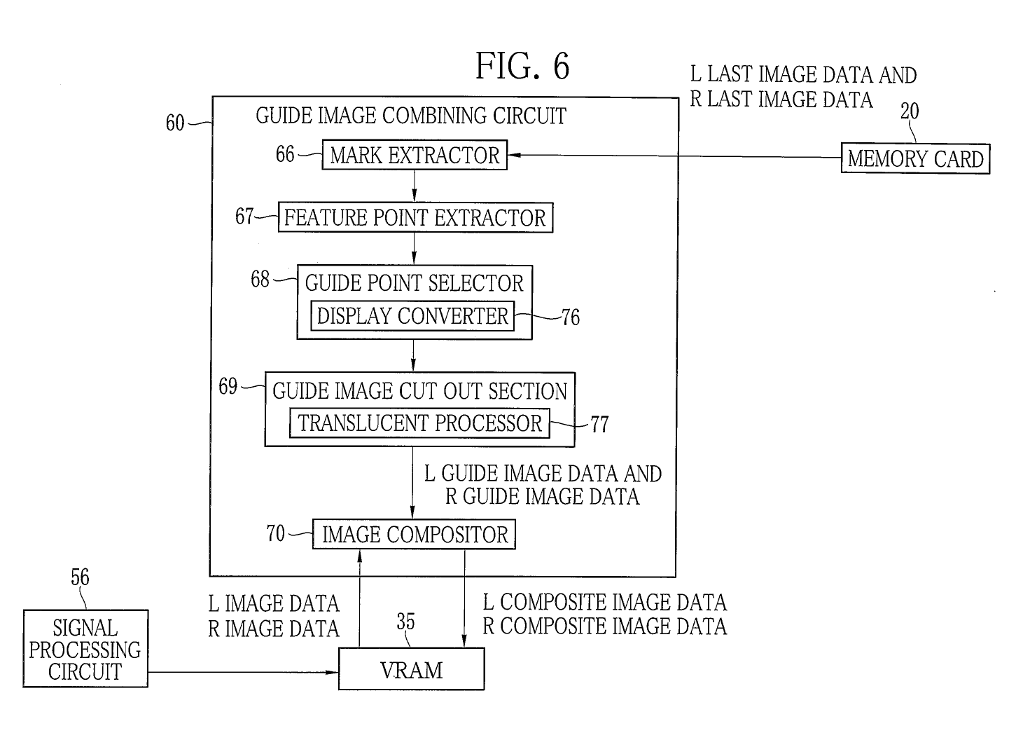

As shown in FIG. 6, the guide image combining circuit 60 is composed of a mark extractor 66, a feature point extractor 67, a guide point selector 68, a guide image cut out section 69, and an image compositor 70.

Information such as color and shape about marks 31 used as feature points (characteristic points) 73 is previously stored in the mark extractor 66. During the standby of the image capture of the Nth L image and the Nth R image, the mark extractor 66 reads (N−1) th L image data (hereinafter referred to as L last image data or L prior image data) and (N−1)th R image data (hereinafter referred to as R last image data or R prior image data) from the memory card 20. Then, the mark extractor 66 performs arithmetic process such as pattern matching to the L last image data and the R last image data, and extracts all the marks 31 contained in each of the L last image data and the R last image data.

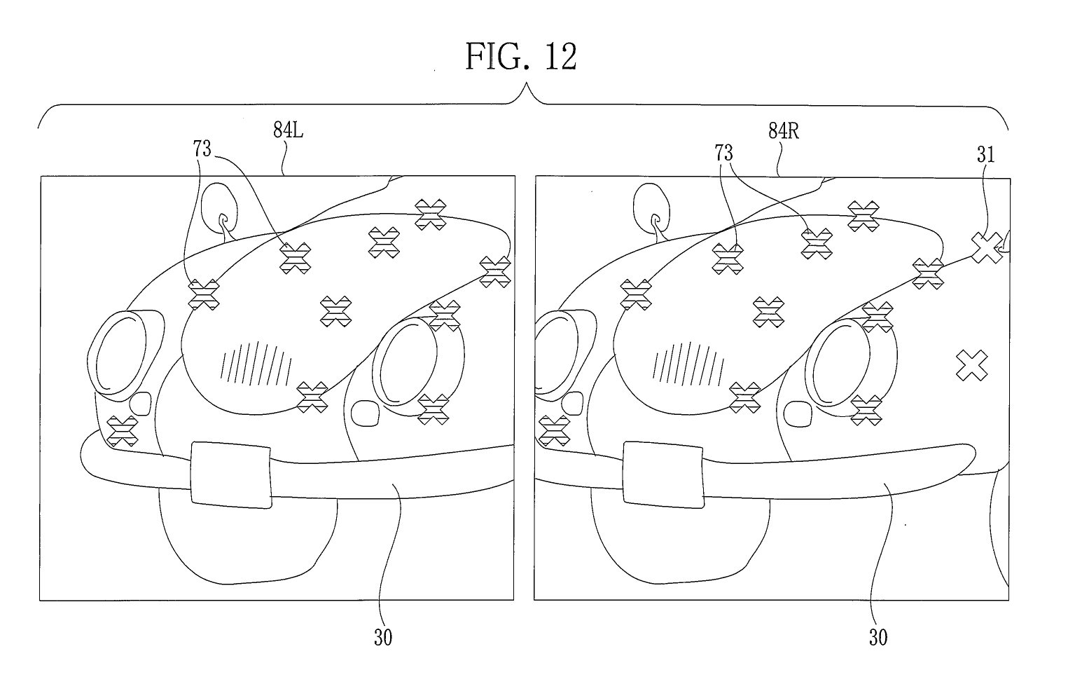

The feature point extractor 67 is provided with an arithmetic circuit for block matching algorithm. The block matching refers to a method in which a reference image is divided into multiple small blocks to find their best matching blocks in another image. The feature point extractor 67 performs the block matching algorithm to the L last image data and the R last image data, and extracts all the marks 31 common to the L last image data and the R last image data (hereinafter referred to as feature points 73, see FIG. 12).

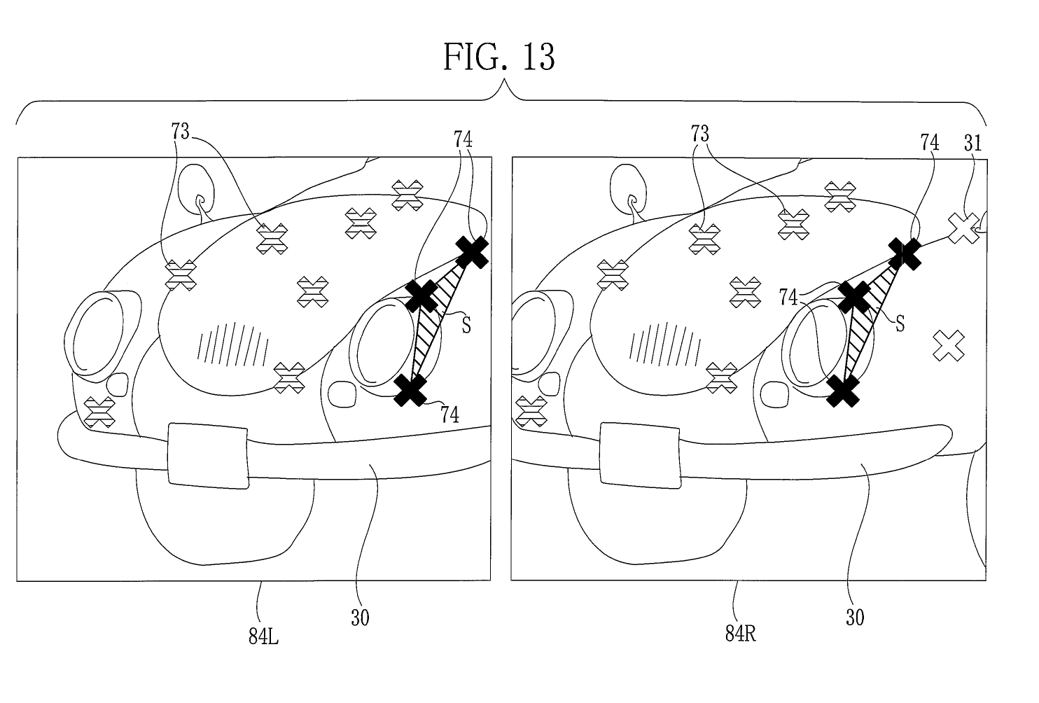

The guide point selector 68 selects some of the feature points 73, extracted by the feature point extractor 67, as guide points 74 (see FIG. 13). The guide points 74 are used for image registration of two adjacent 3D images, the (N−1)th 3D image and the Nth 3D image in the image stitching. The (N−1)th 3D image is generated based on the (N−1)th L image data and the (N−1)th R image data. The Nth 3D image is generated based on the Nth L image data and the Nth R image data.

In each of the L last image and the R last image, from the edge in the camera shift direction toward the direction opposite to the camera shift direction, the guide point selector 68 selects at least three feature points 73. The guide point selector 68 continues to select the feature points 73 as the guide points 74 until an area of a region defined by the selected guide points 74 is equal to or larger than a predetermined threshold value.

The guide point selector 68 is provided with a display converter 76. The display converter 76 as an enhancement unit converts or changes the display condition of the guide points 74 selected by the guide point selector 68 such that the guide points 74 are easily distinguished from the remaining feature points 73.

From each of the L last image data and the R last image data, the guide image cut out section 69 cuts out an edge portion, containing all the guide points 74, on the camera shift direction side. The guide image cut out section 69 generates L guide image data and R guide image data from the cut-out edge portions, respectively. Each of the L guide image data and the R guide image data serves as a guide to determine an appropriate camera position for the next image capture so as to make an overlapping width between the L last image data and the next L image data and an overlapping width between the R last image data and the next R image data at appropriate size. The edge portions (L guide image and R guide image) cut out from the L last image data and the R last image data, respectively, are determined to have the same shape and the same size.

A translucent processor 77 is provided in the guide image cut out section 69. The translucent processor 77 performs translucent process to each of the L guide image data cut out from the L last image data and the R guide image data cutout from the R last image data.

The image compositor 70 reads from the VRAM 35 the L image data and the R image data used as the through images. The image compositor 70 combines the L guide image to an edge portion of the L image data in the opposite direction of the camera shift direction to generate L composite image data. The image compositor 70 combines the R guide image to an edge portion of the R image data in the opposite direction of the camera shift direction to generate R composite image data. The image compositor 70 stores the L composite image data and the R composite image data in the VRAM 35.

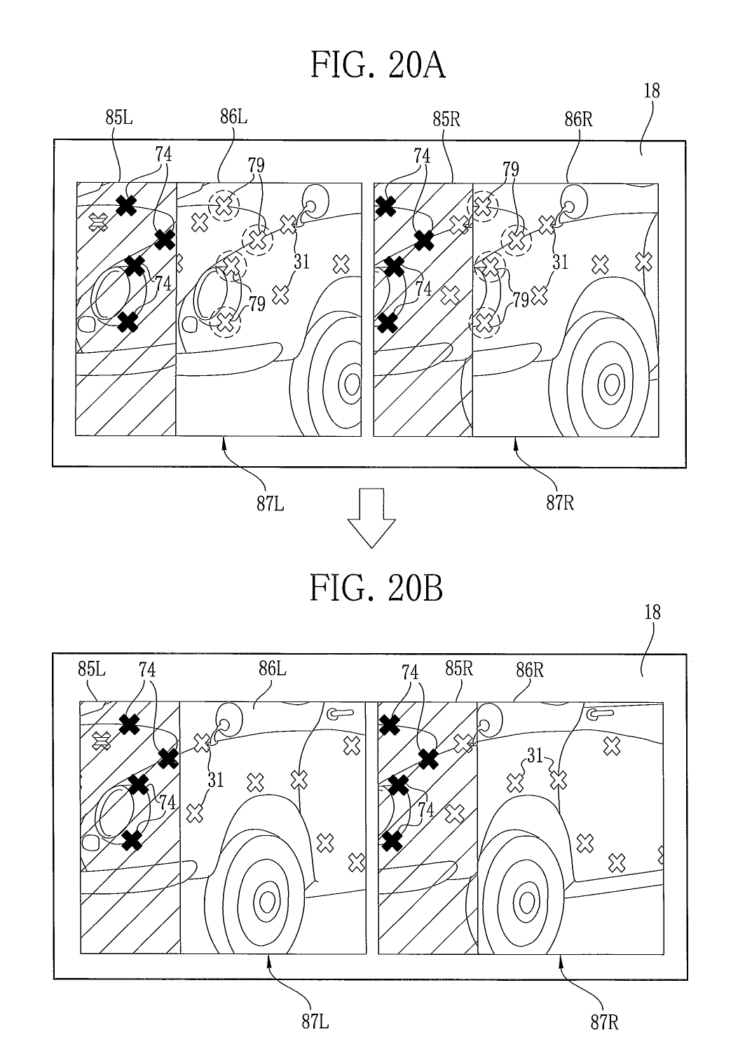

In FIG. 5, the matching point extracting circuit 61 extracts matching points 79 (see FIG. 20A) each corresponding to the guide point 74. The matching points 79 are the feature points 73 used for the alignment of the (N−1)th 3D image and the Nth 3D image to synthesize the (N−1)th 3D image and the Nth 3D image. The matching points 79 in the Nth image are the same feature points 73 as those selected as the guide points 74 in the (N−1)th image, and the Nth image is captured from a camera position different from that of the (N−1)th image.

To be more specific, the matching point extracting circuit 61 executes processes for extracting all the marks 31 (hereinafter referred to as mark extraction process), processes for extracting the feature points 73 (hereinafter referred to as feature point extraction process), and processes for extracting the matching points 79 (hereinafter referred to as matching point extraction process) in this order. In the mark extraction process, all the marks 31 contained in each of the L image data and R image data are extracted in the same manner as with the above mark extractor 66. In the feature point extraction process, the feature points 73, namely, the marks 31 common to the L image data and the R image data are extracted in the same manner as with the feature point extractor 67. In the matching point extraction process, the matching points 79 (see FIG. 20A) corresponding to the guide points 74 are extracted in each of the L last image and the R last image. For example, the above described block matching method is used in the matching point extraction process.

The CPU 33 functions as a storage controller 81 for controlling storage of the captured image data in the memory card 20 by sequentially executing the various programs read from the ROM. When an order to perform the image capture is issued in a mode other than the 3D model capture mode, the storage controller 81 stores in the memory card 20 the compressed image data (image file) compressed by the compression and decompression processing circuit 57.

On the other hand, when an order to perform the image capture is issued in the 3D model capture mode, the storage controller 81 stores in the memory card 20 the uncompressed L image data and R image data, for example, in a RAW format or in a bitmap format. This is because pixel to pixel correspondence between the L image and the R image is performed using the pattern matching, the stereo matching, or the like when distance calculation is performed to obtain a 3D image (3D shape) from the L image data and R image data during the generation of the 3D model. In other words, the irreversible compression of the L image data and R image data in, for example, JPEG format causes errors in the result of the pattern matching or the like.

The storage controller 81 sequentially stores in the memory card 20 the extraction result of the feature points 73 extracted using the feature point extractor 67, the selection result of the guide points 74 extracted using the guide point selector 68, the extraction result of the feature points 73 and the selection result of the matching points 79 extracted and selected using the matching point extracting circuit 61.

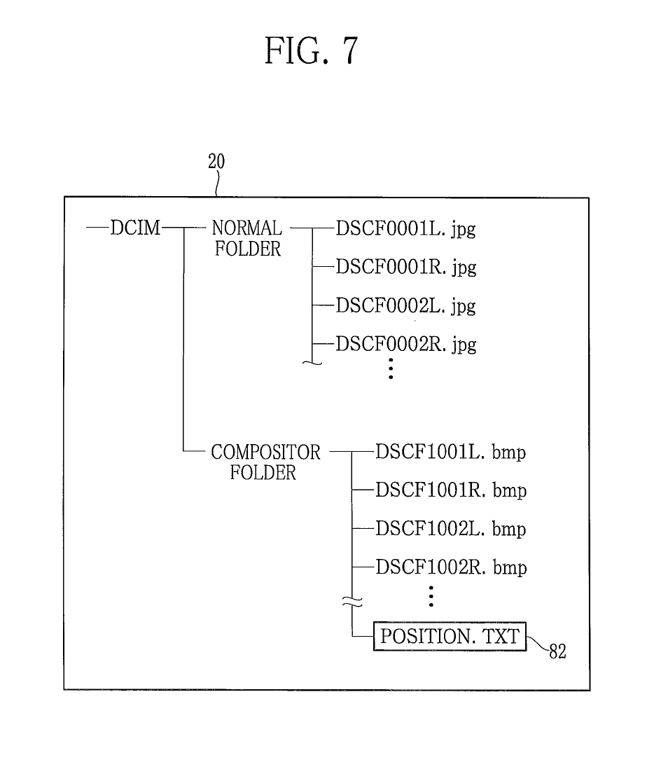

As shown in FIG. 7, the memory card 20 is provided with a NORMAL folder and a COMPOSITOR folder. In the NORMAL folder, the L image data and R image data obtained in a mode other than the 3D model capture mode and compressed in JPEG format are stored. In the COMPOSITOR folder, the uncompressed bitmap L image data and R image data obtained in the 3D model capture mode are stored. The COMPOSITOR folder is provided with a POSITION.TXT 82. In the POSITION.TXT 82, the extraction result and the selection result of the feature point extractor 67, the guide point selector 68, and the matching point extracting circuit 61 are stored.

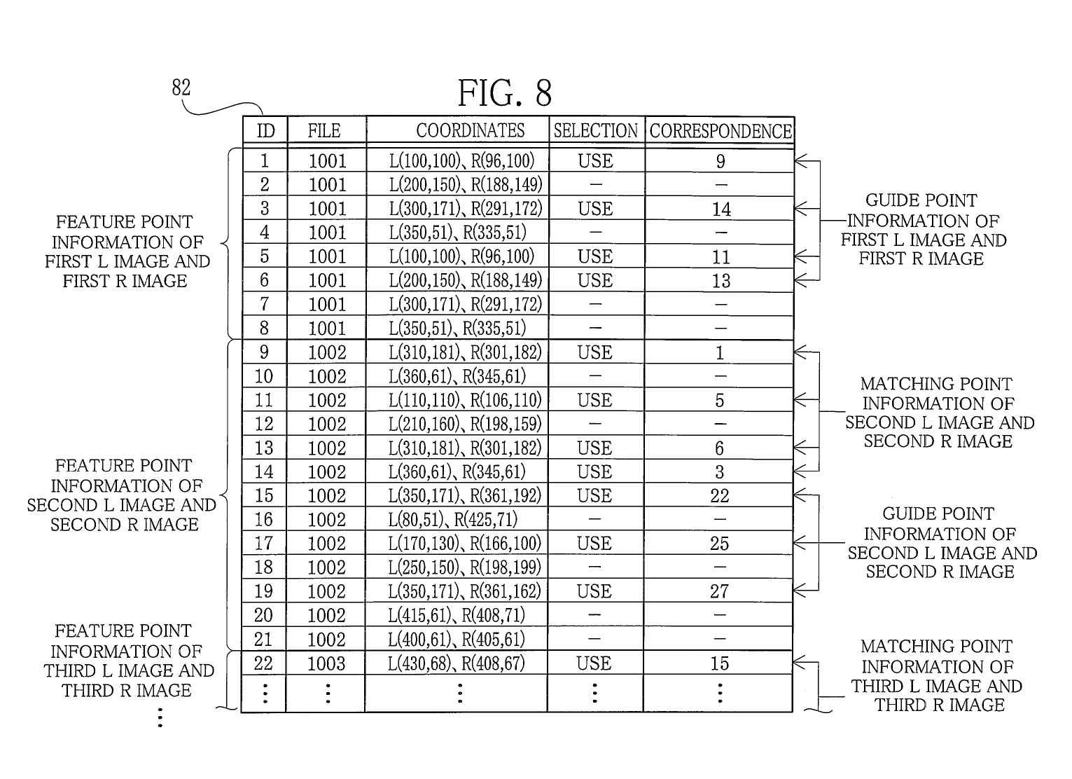

As shown in FIG. 8, the information about the feature points 73 or feature point information of the first pair, second pair, . . . , and Nth pair of the L image and R image is sequentially stored in the POSITION.TXT 82. Each feature point information is composed of ID information, file name information, coordinate information, selection information and correspondence information.

The ID information is provided to uniquely identify each feature point 73 stored in the POSITION.TXT 82. For example, the number of feature points 73 extracted from each of the first L and R images is 8, so ID1 to ID8 are assigned thereto. And the number of the feature points 73 extracted from each of the second L and R images is 13, so ID9 to ID21 are assigned thereto.

The file name information is a name of a file containing the pair of the L image and R image from which the feature points 73 are extracted. The coordinate information is position coordinates of the feature points 73 in each of the L image and R image.

The selection information indicates the feature points 73 selected as the guide points 74, and the feature points 73 selected as the matching points 79. For example, “USE” is put in the selection information column of the feature points 73 selected as the guide points 74 or the matching points 79 to indicate that these feature points 73 are selected. Specifically, for example, the feature points 73 having the ID numbers of ID1, ID3, ID5, and ID6 are selected as the guide points 74 in each of the first L and R images. The feature points 73 having the ID numbers of ID9, ID11, ID 13, and ID14 are selected as the matching points 79 in each of the second L and R images.

The correspondence information shows correspondence between the guide points 74 in the (N−1)th L image and the matching points 79 in the N th L image, and the correspondence between the guide points 74 in the (N−1)th R image and the matching points 79 in the Nth R image. Specifically, the ID number of the corresponding matching point 79 or the corresponding guide point 74 is put in the correspondence information. For example, the guide points 74 (ID1) in the first L and R images corresponds to the matching points 79 (ID9) in the second L and R images.

In FIG. 5, the 3D model synthesis circuit 62 generates 3D model data of the main subject 30 based on a series of the L and R image data obtained in the 3D model capture mode. First, the 3D model synthesis circuit 62 obtains the 3D image data of each imaging field using the L and R image data. For example, correspondence between a pixel in the L image and a pixel in the R image (position coordinates of each pixel) is obtained using a pattern matching method or the like. Using principles of triangulation, a distance (3D coordinates) between the multi-eye camera 10 and a point on the subject corresponding to each of the pixel in L and R images is calculated based on the position coordinates of each pixel and previously measured stereo calibration data, which is referred as so-called distance calculation. Thus, 3D image (range image) data representing a 3D shape of each imaging field is obtained.

Next, the 3D model synthesis circuit 62 synthesizes 3D image data of adjacent imaging fields. Specifically, 3D coordinates of the guide points 74 contained in the 3D image of the (N−1)th imaging field and 3D coordinates of the matching points 79 contained in the 3D image of the Nth imaging field are obtained by the above distance calculation. The POSITION.TXT 82 indicates the correspondence between the guide points 74 in the (N−1)th 3D image and the matching points 79 in the Nth 3D image. The 3D model synthesis circuit 62 rotates or translates one of the 3D images relative to the other so as to overlap the guide point 74 and its corresponding matching point 79 with each other or minimize a distance between the guide point 74 and its corresponding matching point 79 to synthesize the 3D images. Thereby, 3D model data of the subject is generated.

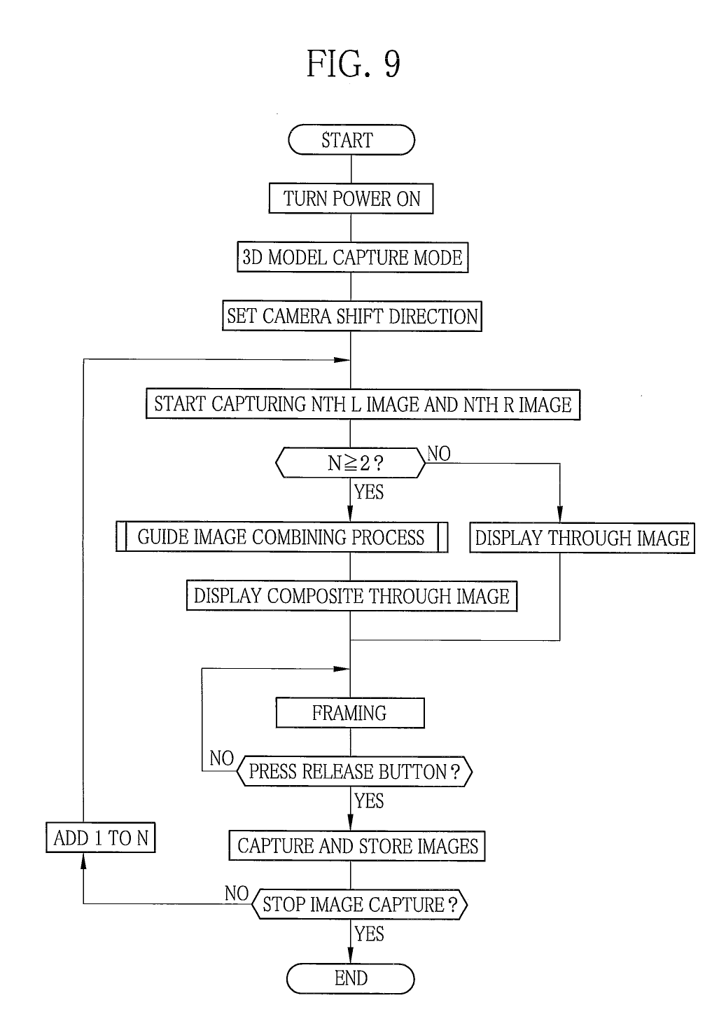

With referring to flowcharts of FIGS. 9 and 10, and FIGS. 11 to 20, processes in the 3D model capture mode of the above-configured multi-eye camera 10 is described. In FIG. 9, when the power is turned on, the CPU 33 loads the control program from the ROM to start controlling the operations of the multi-eye camera 10. After the mode selection switch 22 is set in the 3D model capture mode, the direction designation switch 26 designates the camera shift direction as “right”, for example.

The subject light incident on the CCD 39 through the taking lens system 37 of the first imaging unit 12 is photoelectrically converted in the CCD 39, and then converted into a digital image signal in the AFE 40. The subject light incident on the CCD 48 through the taking lens system 37 of the second imaging unit 13 is photoelectrically converted into a digital image signal in the CCD 48, and then converted into a digital image signal in the AFE 49. The L image signal output from the first imaging unit 12 and the R image signal output from the second imaging unit 13 are sent to the signal processing circuit 56 through the image input controller 45, and subjected to various processes. Thus, one frame of the L image data and one frame of the R image data are stored in the VRAM 35. The L image data and the R image data are successively stored in the VRAM 35 at a predetermined frame rate.

When the multi-eye camera 10 is on standby for capturing the first L image and the first R image, the CPU 33 issues an order to the display circuit 59 to display a through image. Upon receipt of the order, the display circuit 59 reads the L image data and the R image data from the VRAM 35 and displays the L image and the R image as the through image on the LCD 18. After the framing of the main subject 30 with the LCD 18, the release button 15 is half pressed. Thereby, the preparatory processes for the image capture such as focus control and exposure control are performed, and the multi-eye camera 10 becomes ready for the image capture.

After the preparatory processes, a first imaging field of the main subject 30 is captured in response to the full pressing operation of the release button 15. The image signal of one frame is read from each of the CCDs 39 and 48. The image signals read from the CCDs 39 and 48 are subjected to predetermined signal processes in the AFEs 40 and 49, respectively, and then in the signal processing circuit 56. Thus, the L image data and R image data are stored in the VRAM 35. Then, the storage controller 81 of the CPU 33 sends the uncompressed L image data and the uncompressed R image data stored in the VRAM 35 to the media controller 58. The uncompressed L image data and the uncompressed R image data are stored in the COMPOSITOR folder in the memory card 20 via the media controller 58.

After the first L and R images are captured and stored, the camera position of the multi-eye camera 10 is shifted to the right around the main subject 30. In addition, after the first L and R images are captured and stored, the CPU 33 issues an order to generate the guide image to the guide image combining circuit 60. Upon receiving this order, each section of the guide image combining circuit 60 actuates.

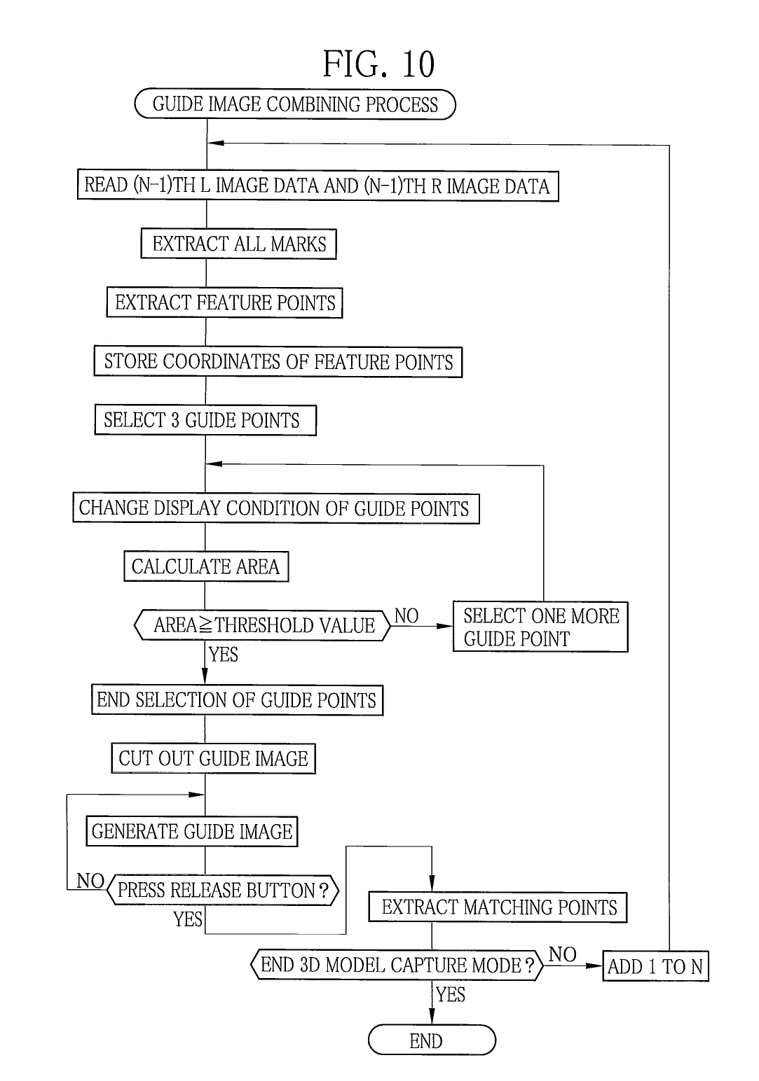

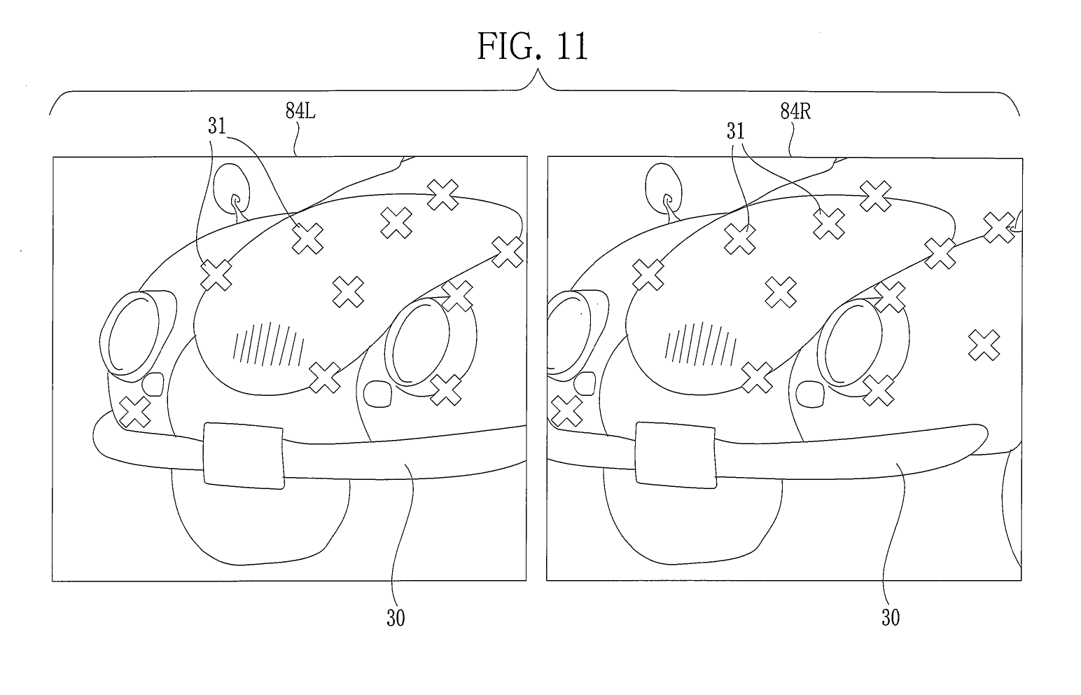

As shown in FIG. 10, the mark extractor 66 reads data of the first L and R images and the like from the memory card 20 via the media controller 58. Then, as shown in FIG. 11, using a pattern matching method, the mark extractor 66 extracts all the marks 31 contained in each of L and R images 84L and 84R based on the previously stored information such as the shape of the marks 31. The mark extractor 66 sends the result of the extraction of the marks 31 contained each of the L and R images to the feature point extractor 67.

As shown in FIG. 12, using a block matching method and based on the extraction result input from the mark extractor 66, the feature point extractor 67 extracts all the feature points 73 (with horizontal stripes) common to the first L and R images 84L and 84R. For example, all the marks 31 in the L image 84L are contained in the R image 84R. On the other hand, two white marks 31 in the right edge portion of the R image 84R are not contained in the L image 84L. In this case, the feature point extractor 67 extracts all the marks 31 except for the two white marks 31 as the feature points 73. The feature point extractor 67 sends the extraction result of the feature points 73 contained in each of the L and R images 84L and 84R to the guide point selector 68.

Based on the extraction result of the feature point extractor 67, the storage controller 81 generates the feature point information (see FIG. 8) of the first L and R images 84L and 84R. Then, the storage controller 81 stores the generated feature point information in the POSITION.TXT 82 of the memory card 20 via the media controller 58.

As shown in FIG. 13, from the right edge portion toward the left direction in each of the L and R images 84L and 84R, the guide point selector 68 selects three feature points 73 as the guide points 74. The display converter 76 converts or changes the display condition of the guide points 74 (filled in black) such that the guide points 74 are easily distinguished from the remaining feature points 73. Thereby, the guide points 74 become relatively prominent in each of the L and R images 84L and 84R.

After the guide points 74 are selected, the guide point selector 68 obtains an area of the region S (diagonally shaded) defined by the selected three guide points 74. The area of the region S is obtained by counting the number of pixels in the region S. Then, the guide point selector 68 judges whether the area of the region S is equal to or larger than a predetermined threshold value.

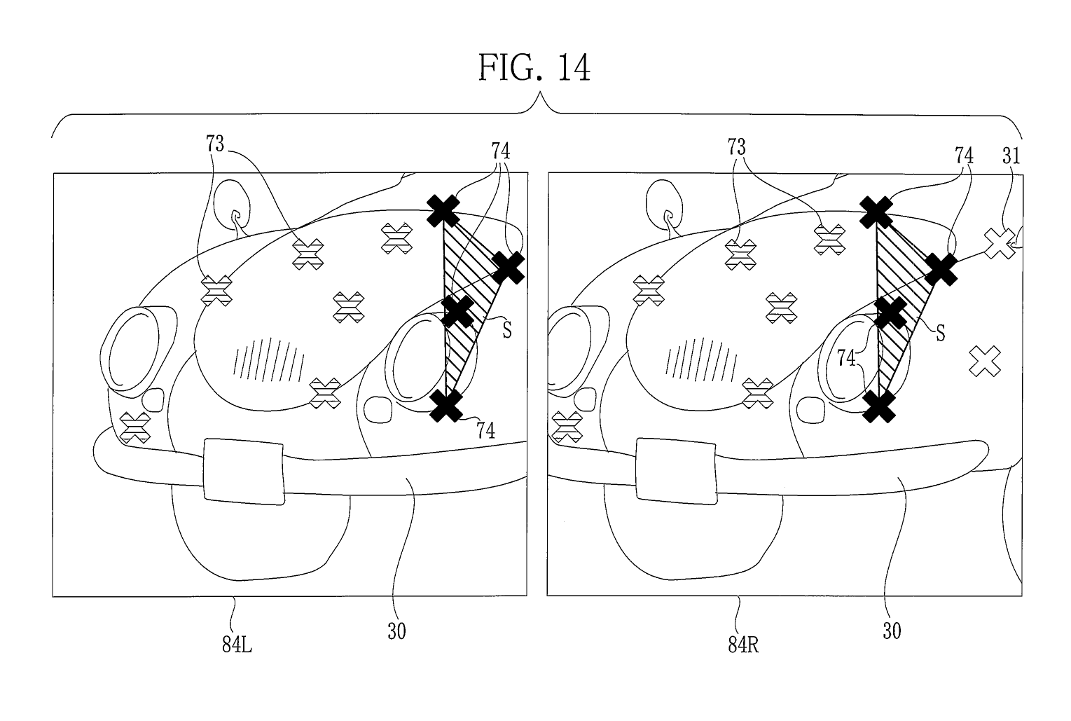

As shown in FIG. 14, in the case where the guide point selector 68 judges that the area of the region S is smaller than the threshold value, the guide point selector 68 selects as the guide point 74 another feature point 73 nearest to the right edge portion from the rest of the feature points 73. The display condition of this newly selected guide point 74 is also changed in the same way as that of the previously selected guide points 74. Then, the guide point selector 68 judges whether the area of the region S defined by the selected guide points 74 is equal to or larger than the threshold value. If not, the guide point selector 68 continues to select another guide point 74 until the area of the region S becomes equal to or larger than the threshold value.

As shown in FIG. 13, when the area of the region S is smaller than a threshold value, there is a high possibility that all the guide points 74 are located substantially along a line. As described above, the guide points 74 are used for image registration of 3D images of the adjacent imaging fields to synthesize these 3D images. Specifically, the 3D images are synthesized such that each guide point 74 and the corresponding matching point 79 substantially overlap each other. In other words, the 3D images are synthesized such that a portion defined by the guide points 74 in the (N−1)th 3D image and a portion defined by the matching points 79 in the Nth 3D image overlap each other. Accordingly, if all the guide points 74 in one image are located substantially along a line, namely, when the area of the portion defined by the guide points 74 is small, the image synthesis may fail.

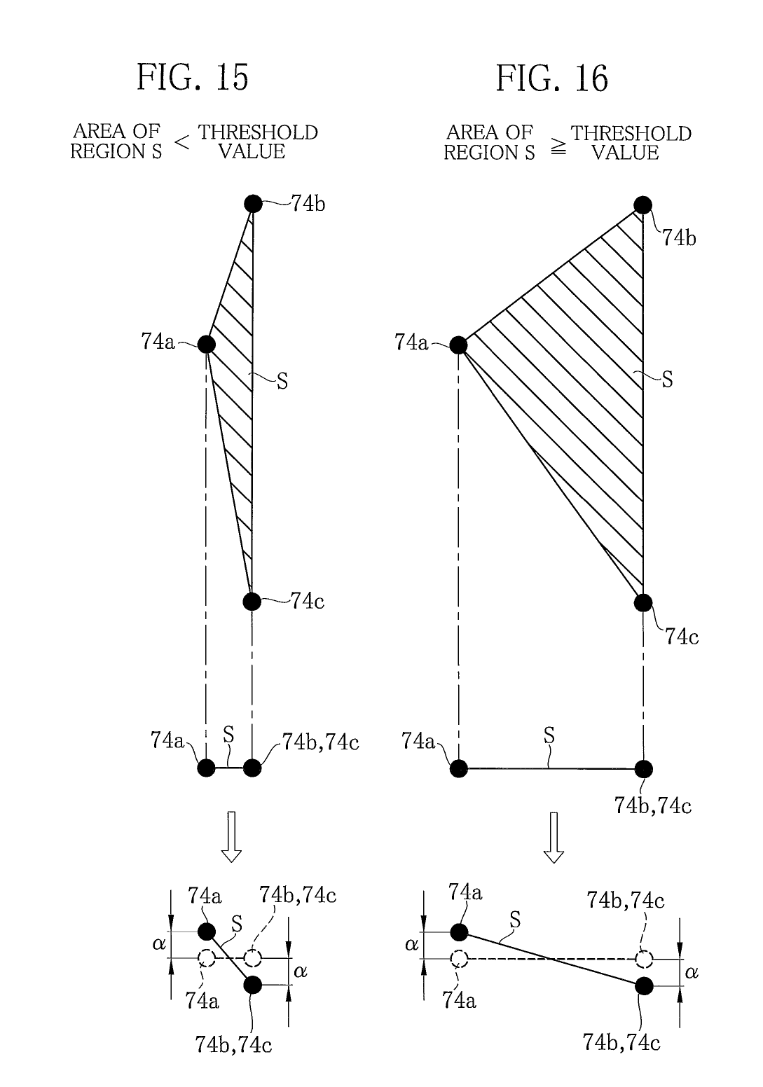

As shown in FIG. 15, when guide points 74a to 74c are located substantially along a line or when the area of the region S is smaller than the threshold value (area of the region S<the threshold value), a width of the region S becomes extremely narrow in one direction (for example, the lateral direction in FIG. 15). In this case, if there are errors in positions of the guide points 74a to 74c obtained using the distance calculation, for example, the guide point 74a is shifted “α” in the upward direction and the guide points 74b and 74c are shifted “α” in the downward direction in the drawing, an inclination error of the region S becomes significantly large compared to the case where the area of the region S is equal to or larger than the threshold value (area of region S≧threshold value) as shown in FIG. 16. As a result, the synthesis of the 3D images fails. To prevent the guide points 74 from being located substantially along a line, an additional guide point 74 is selected until the area of the region S defined by the guide points 74 becomes equal to or larger than the threshold value.

After the guide points 74 are properly selected, the storage controller 81 stores, via the media controller 58, the selection result of the guide points 74 in the feature point information of the first L and R images previously stored in the POSITION.TXT 82. Thereby, “USE” is put in the selection information column of the feature points 73 selected as the guide points 74 (see FIG. 8).

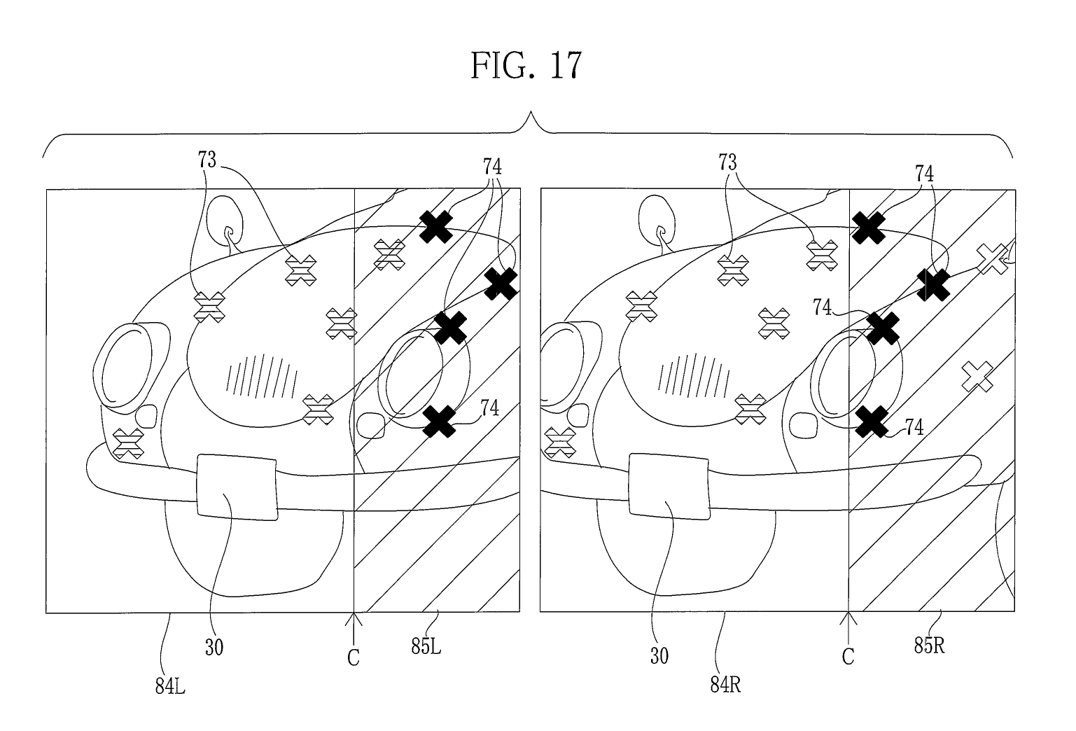

As shown in FIG. 17, the guide image cut out section 69 detects the leftmost guide point 74 in each of the first L and R images 84L and 84R. The guide image cut out section 69 defines a position slightly left of the position coordinate (X coordinate) of the leftmost guide point 74 as a cut out position C in each of the first L and R images 84L and 84R.

Then, the guide image cut out section 69 cuts out the right edge portion (diagonally shaded), located to the right of the cut out position C, from each of the first L and R images 84L and 84R to generate L and R guide images 85L and 85R, respectively. The generated L and R guide images 85L and 85R are made translucent by the translucent processor 77. Thereafter, the L and R guide images 85L and 85R (L and R guide image data) are sent to the image compositor 70.

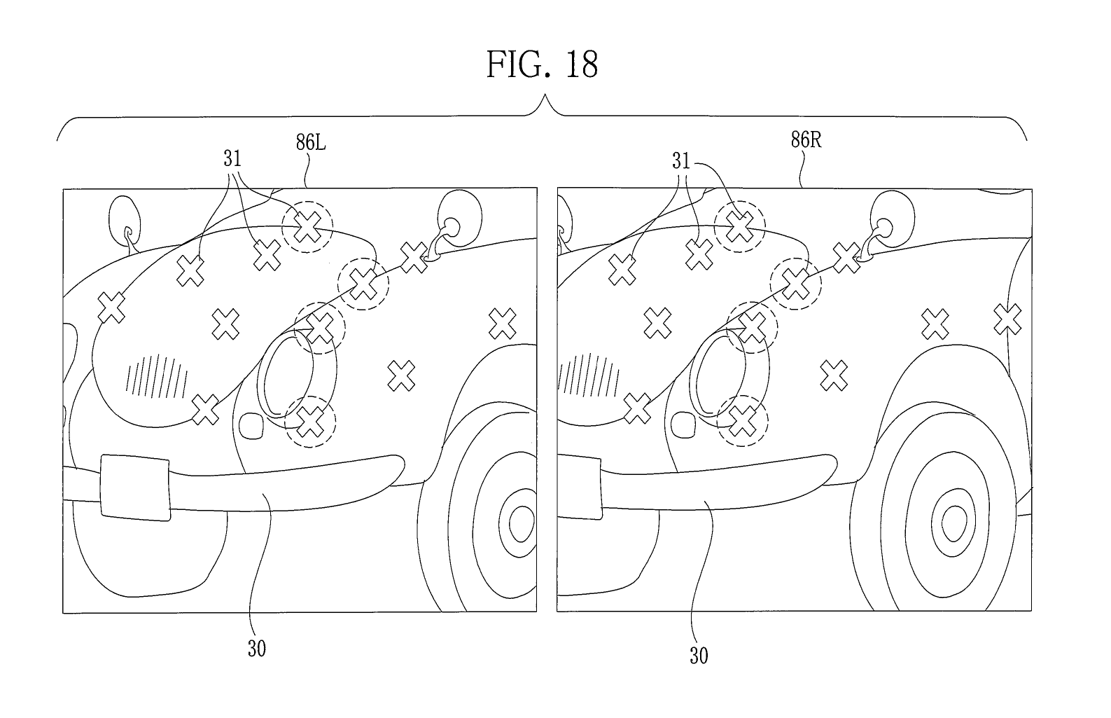

The image compositor 70 reads from the VRAM 35 the L and R image data used for generating the through image. As shown in FIG. 18, in the case where the present camera position is shifted to the right from the first camera position, L and R images 86L and 86R that are shifted to the right from the first L and R images 84L and 84R are obtained. Dashed circles in FIG. 18 are shown for the convenience of indicating the marks 31 to be used as the matching points 79, namely, the marks 31 selected as the guide points 74 in the last image capture. The dashed circles are not actually displayed on the screen.

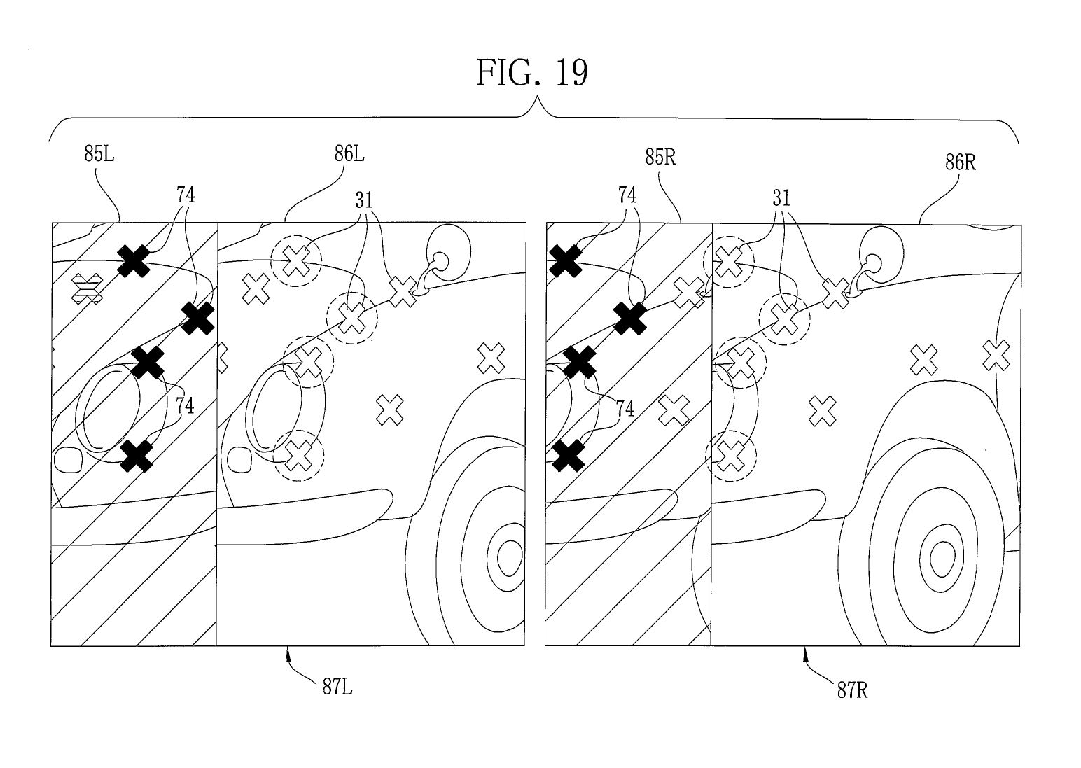

As shown in FIG. 19, the image compositor 70 combines the L guide image 85L with the L image 86L at the left edge portion of the L image 86L to generate L composite image 87L, and combines the R guide image 85R with the R image 86R at the left edge portion of the L image 86R to generate R composite image 87R. The image compositor 70 stores the generated L and R composite images 87L and 87R (L and R composite image data) in the VRAM 35. In the same manner, the image compositor 70 generates the L and R composite image data and stores them in the VRAM 35 every time new L and R image data are stored in the VRAM 35. The CPU 33 issues the order to display the through images to the display circuit 59 every time the new L and R composite image data are stored in the VRAM 35.

As shown in FIG. 20A, upon receiving the order to display the through image, the display circuit 59 reads the L and R composite image data from the VRAM 35, and displays the L and R composite images 87L and 87R as the through images on the LCD 18. Since the L and R guide images 85L and 85R are translucent, the left edge portions of the L and R images 86L and 86R are visually identified. Alternatively, only one of the L and R composite images 87L and 87R may be displayed on the LCD 18.

A camera operator determines the second camera position based on the L and R composite images 87L and 87R displayed side by side on the LCD 18. To overlap and synthesize the first and second 3D image data, it is necessary that the second 3D image data (the L and R image data) contains the matching points 79. To capture the entire main subject 30 with the minimum number of captures, it is necessary that the matching points 79 are located in the left edge portion of the next 3D image data. The second camera position satisfying these two conditions is a position where all the matching points 79 in the L image 86L and the L guide image 85L overlap each other, and all the matching points 79 in the R image 86R and the R guide image 85R overlap each other. Thus, each of the L and R guide images 85L and 85R serves as the guide to determine an overlapping area between the immediately preceding or last imaging field and the next imaging field, that is, the next camera position.

Since the guide points 74 are relatively prominent in the L and R guide images 85L and 85R, the camera operator easily finds the guide points 74. Thereby, the camera operator easily discriminates the matching points 79 in the L and R images 86L and 86R based on the arrangements and the positional relations of the guide points 74. Accordingly, as shown in FIG. 20B, the camera position is determined such that all the matching points 79 in the L image 86L and the L guide image 85L overlap each other, and all the matching points 79 in the R image 86R and the R guide image 85R overlap each other.

In determining the camera position, it is not necessary to completely overlay the guide points 74 with the corresponding matching points 79. It is only necessary that a region defined by the matching points 79 in the L image 86L is within the L guide image 85L, and a region defined by the matching points 79 in the R image 86R is within the R guide image 85R. Unlike the image composition of the 2D images in generating a panoramic image, an overlapping width of imaging fields necessary for appropriately synthesizing the 3D images vary according to the surface conditions of the main subject 30. In the multi-eye camera 10, the overlapping width is adjusted to an optimum value by shifting the cut out position C (see FIG. 17) as necessary based on the selection result of the guide points 74. Thus, determining the camera position based on the L and R composite images 87L and 87R prevents failure in the synthesis of the 3D image.

In FIG. 9, after the framing, the preparatory processes for the image capture are performed when the release button 15 is half-pressed. Then, in response to the full-press operation of the release button 15, an image of the second imaging field of the main subject 30 is captured. Thereby, the storage controller 81 stores the second uncompressed L and R image data in the COMPOSITOR folder of the memory card 20 via the media controller 58.

Before the second uncompressed L and R image data are stored in the memory card 20, the matching point extracting circuit 61 performs the above described mark extraction process, the feature point extraction process, and the matching point extraction process in this order to the second L and R image data.

At this time, the storage controller 81 generates the feature point information of the second L and R images 84L and 84R based on the common feature points 73 extracted in the feature point extraction process. This feature point information is stored in the POSITION.TXT 82 of the memory card 20 (see FIG. 8). Then, the storage controller 81 stores the extraction result of the matching points 79 in the stored feature point information based on the matching points 79 extracted in the matching point extraction process. Thereby, “USE” is put in the selection information column of the feature points 73 selected as the matching points 79.

In the feature point information of the first L and R images and of the second L and R images, the storage controller 81 stores the correspondence information for indicating the correspondence between the guide points 74 in the first L and R images and the matching points 79 in the second L and R images based on the matching points 79 extracted in the matching point extraction process. Thus, the ID number of the corresponding matching point 79 is displayed in the correspondence information column of the guide point 74. The ID number of the corresponding guide point 74 is displayed in the correspondence information column of the matching point 79.

The above described series of processes are performed repeatedly, until the images of all the imaging fields of the main subject 30 are captured to cover the entire surface of the main subject 30, and thus all the imaging fields of the main subject 30 are stereoscopically captured. For each imaging field, the L image data, the R image data, and the feature point information (feature point and matching point information) are stored in the memory card 20.

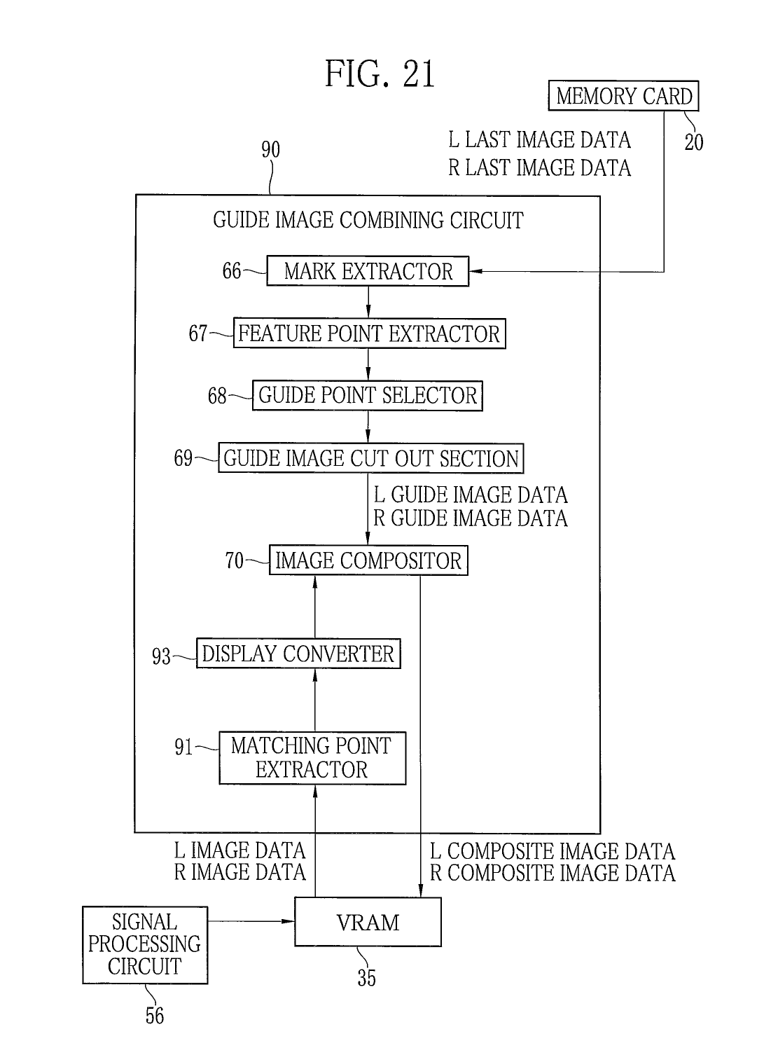

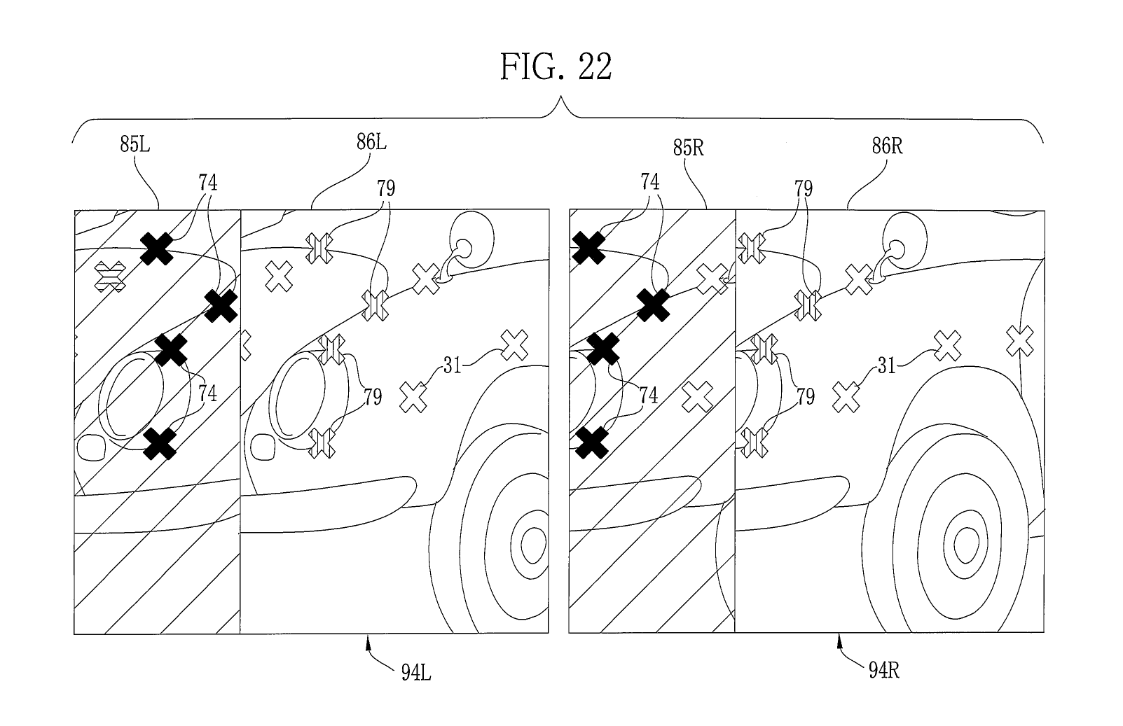

Next, with referring to FIGS. 21 and 22, a multi-eye camera of a second embodiment is described. In the first embodiment, the feature points 73 used as the guide points 74 are prominently displayed relative to the remaining feature points 73 in the display. In the second embodiment, in addition to the guide points 74, the marks 31 used as the matching points 79 are also prominently displayed relative to the remaining marks 31 in the display. The multi-eye camera of the second embodiment has the same configuration as the first embodiment except for a guide image combining circuit 90 (see FIG. 21) different from the guide image combining circuit 60 of the first embodiment. A component the same or similar to that of the first embodiment is designated by the same numeral as the first embodiment, and descriptions thereof are omitted.

As shown in FIG. 21, the guide image combining circuit 90 basically has the same configuration as the guide image combining circuit 60 of the first embodiment. However, the guide image combining circuit 90 further includes a matching point extractor (second feature point extractor) 91 and a display converter (second display converter) 93 or enhancement unit.

The matching point extractor 91 is basically the same as the matching point extracting circuit 61 of the first embodiment. Every time the newly captured L and R images 86L and 86R from the signal processing circuit 56 are stored in the VRAM 35, the matching point extractor 91 reads the L and R images 86L and 86R from the VRAM 35 and performs the mark extraction process, the processes for extracting the feature points (second feature points) 73, and the matching point extraction process in this order. Thereby, the matching points 79 contained in the L and R images 86L and 86R are extracted.

The display converter 93 converts or changes the display condition of the matching points 79, extracted by the matching point extractor 91, such that the matching points 79 are easily distinguished from the remaining feature points 73. Thereafter, the display converter 93 sends the L and R images 86L and 86R to the image compositor 70. If the matching points 79 are not extracted by the matching point extractor 91, the display converter 93 sends the L and R image data to the image compositor 70 without changing the display condition.

As shown in FIG. 22, in each of L and R composite images 94L and 94R generated by the image compositor 70, the matching points 79, in addition to the guide points 74, are displayed prominent relative to the remaining marks 31. As a result, in the second embodiment, the camera position is determined more easily than in the first embodiment.

In the above embodiments, the L image data, the R image data, and the POSITION.TXT 82 are separately stored in the memory card 20. Alternatively, for example, the L and R image data may be put in an image file and this image file may be stored in the memory card 20. Information contained in the POSITION.TXT 82 may be incorporated in this image file.

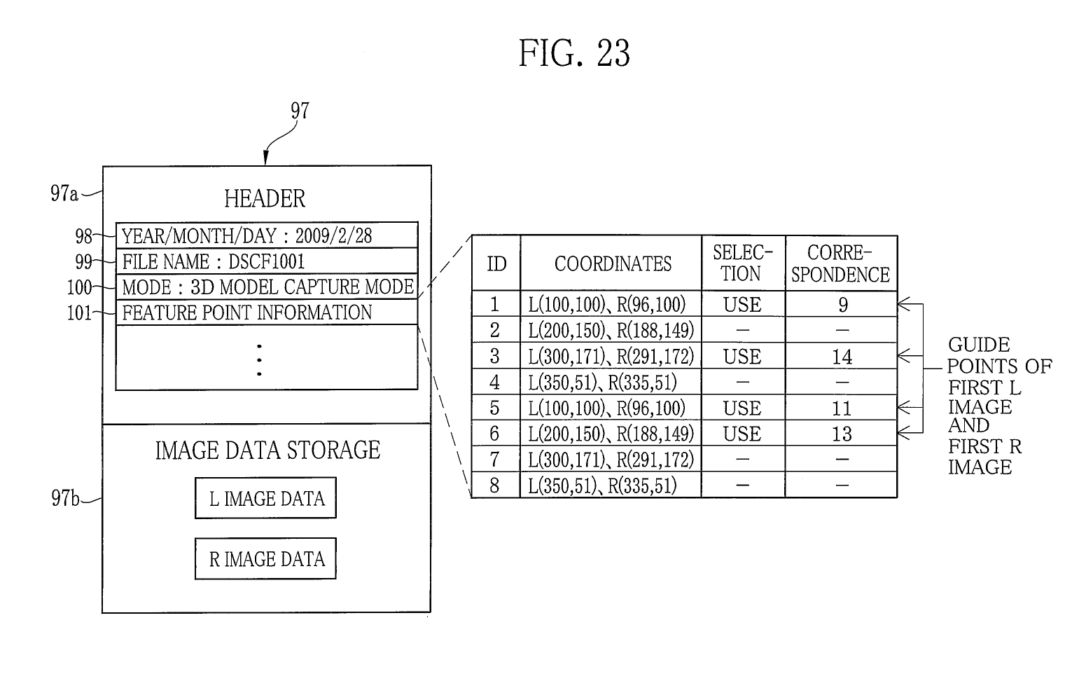

As shown in FIG. 23, header information is stored in a header 97a of an image file 97. The L and R image data are stored in an image data storage 97b. The header information includes Y/M/D (Year/Month/Day) information 98 indicating the date of image capture, file name information 99, operation mode information 100, feature point information 101, and the like.

In the feature point information 101, information basically the same as the feature point information stored in the POSITION.TXT 82 is stored. FIG. 23 shows the image file 97 of the first L and R images as an example, so the matching point information for the last stored images or immediately preceding images is not contained therein.

In the above embodiments, the marks 31 or marking materials are previously attached to the main subject 30. The images of the marks 31 are extracted from the L and R images, and then the guide points 74 and the matching points 79 are selected from the extracted marks 31. Alternatively, for example, characteristic points in which pixel value variations are significant, for example, corners and/or edges of the subject may be extracted as the feature points. The guide points 74 and the matching points 79 for aligning the images may be selected from the extracted feature points. For example, methods of Harris, Moravec, or Shi-Tomashi may be used for extracting the feature points.

In the above embodiments, a 3D model is generated using the multi-eye camera. Alternatively or in addition, a 3D model may be generated using a personal computer or the like.

In the above embodiments, the guide image cut out section 69 performs the translucent process to the L and R guide images. The translucent process may be performed by, for example, the image compositor 70 or the display circuit 59.

In the above embodiments, the camera shift direction can be designated as desired using the direction designation switch 26. For example, the camera shift direction may be previously set in one direction, for example, to the right. The multi-eye camera 10 may be provided with a 3-axis acceleration sensor, and a moving direction of the multi-eye camera 10 detected with this sensor may be designated as the camera shift direction. The multi-eye camera 10 may be provided with an orientation detection sensor so as to easily designate the camera shift direction in accordance with the orientation of the multi-eye camera 10 even if the orientation of the multi-eye camera 10 is changed, for example, vertically or horizontally.

In the above embodiments, the L and R images are displayed side by side as through images on the LCD 18. Alternatively, for example, the R image is fully displayed on the LCD 18 in the case where the camera shift direction is to the right, and the L image is fully displayed on the LCD 18 in the case where the camera shift direction is to the left. In this case, the guide image combining circuit 60 selects, from the L and R last images read from the memory card 20, the last image captured with the same imaging unit used for capturing the through images. The guide image combining circuit 60 generates the guide image and the composite image based on the selected last captured image. For example, when the R image is displayed as the through image, the R last image is selected from the L and R last images read from the memory card 20. The R guide image and the R composite image are generated based on this R last image.

In the above embodiments, the selection information and the correspondence information are stored in the feature point information (see FIG. 8) stored in the POSITION.TXT 82. Alternatively, the selection information and the correspondence information may be integrated into the correspondence information. Specifically, for example, “USE” is put in the correspondence column of the feature points 73 selected as the guide points 74 or the matching points 79. Thereafter, to store the correspondence information, the “USE” in the correspondence column of the feature point 73 selected as the guide point 74 is replaced with the ID number of the corresponding matching point 79, and the “USE” in the correspondence column of the feature point 73 selected as the matching point 79 is replaced with the ID number of the corresponding guide point 74.

In the above embodiments, a multi-eye camera having two imaging units is described as an example of the imaging apparatus. The present invention is also applicable to a multi-eye camera having three or more imaging units. For example, in a three-eye camera having first to third imaging units, the above described image combining processes and the distance calculation processes may be performed based on images captured with two of the three imaging units.

Various changes and modifications are possible in the present invention and may be understood to be within the present invention.

What is claimed is:

1. An imaging apparatus having at least a first imaging unit and a second imaging unit with a space therebetween, a display section for displaying a captured image captured with at least the first imaging unit as a through image during image capture of the through image, and a storage for storing two captured images captured with the first and second imaging units when the image capture is instructed, the imaging apparatus capturing images of a subject from different camera positions shifted around the subject, the imaging apparatus comprising:
a direction designation section for designating a shift direction of the camera position;
a feature point extractor for reading two last stored images from the storage, and extracting characteristic points common to the two last stored images as feature points;
a guide point selector for selecting the feature points located at an edge portion of each of the two last stored images in the designated shift direction as guide points;
a guide image generating section for cutting out the edge portion containing the guide points from the last stored image obtained with at least the first imaging unit, and generating a guide image from the cut out edge portion to indicate an overlapping area of the last stored image and a next image to be stored, the guide image serving as a guide to determine a next camera position; and
an image compositor for combining the guide image with the through image being displayed, the guide image being disposed at an edge portion of the through image opposite to the shift direction.

2. The imaging apparatus of claim 1, wherein the guide point selector selects at least three of said feature points as the guide points in each of the two last stored images at the edge portion in the shift direction.

3. The imaging apparatus of claim 2, wherein the guide point selector selects the guide points such that an area of a region defined by the guide points is equal to or larger than a predetermined value.

4. The imaging apparatus of claim 1, further comprising a first display converter for changing a display condition of the guide points contained in the guide image to be relatively prominent on a screen of the display section.

5. The imaging apparatus of claim 1, wherein the image compositor makes the guide image translucent and combines the translucent guide image with the through image.

6. The imaging apparatus of claim 1, further comprising a storage controller for storing position information indicating the positions of the guide points in each of the two last stored images in the storage, the storage controller storing the position information in association with the corresponding last stored image.

7. The imaging apparatus of claim 6, further comprising:
a second feature point extractor for extracting second feature points, the second feature points being characteristic points common to the two captured images to be stored in the storage when the image capture is instructed; and
a matching point extractor for extracting from the second feature points in each of the two images a matching point corresponding to the guide point;
wherein based on an extraction result of the matching point extractor, the storage controller stores in the storage the position information indicating a position of the matching point in each of the two images in association with the corresponding captured image.

8. The imaging apparatus of claim 7, wherein the storage controller stores correspondence information indicating correspondence between the guide points and the matching points in the storage.

9. The imaging apparatus of claim 7, wherein the display section displays the two captured images as through images, and each of the captured images contains the second feature points and the matching points, and the imaging apparatus further comprising a second display converter for changing a display condition of the matching points in each of the through images to be relatively prominent on a screen of the display section.

10. A method for controlling an imaging apparatus having at least a first imaging unit and a second imaging unit with a space therebetween, a display section for displaying a captured image captured with at least the first imaging unit as a through image during image capture of the through image, and a storage for storing two captured images captured with the first and second imaging units when the image capture is instructed, the imaging apparatus capturing images of a subject from different camera positions shifted around the subject, the imaging apparatus comprising the steps of:
designating a shift direction of the camera position;
reading two last stored images from the storage, and extracting, from each of the two last stored images, characteristic points common to the two last stored images as feature points;
selecting the feature points located at an edge portion of each of the two last stored images in the designated shift direction as guide points;
cutting out the edge portion containing the guide points from the last stored image obtained with at least the first imaging unit, and generating a guide image from the cut out edge portion to indicate an overlapping area of the last stored image and a next image to be stored, the guide image serving as a guide to determine a next camera position; and
combining the guide image with the through image being captured and displaying a combined image on the display section, the guide image being disposed at an edge of the through image in the opposite direction to the shift direction.
